(19) United States
(12) Patent Application Publication
(10) Pub. No.: US 2026/0332449 A1
(43) Pub. Date: Oct. 22, 2026

(54) A METHOD FOR A CONTROL DEVICE OF A VEHICLE TO REDUCE ENERGY CONSUMPTION, A METHOD FOR ACENTRAL CONTROL DEVICE, A COMPUTER PROGRAM, AN APPARATUS AND A VEHICLE

(71) Applicants: BAYERISCHE MOTOREN WERKE AKTIENGESELLSCHAFT, Munich (DE); CONTINENTAL AUTOMOTIVE TECHNOLOGIES GMBH, Hannover (DE)

(72) Inventors: Helmut KELLERMANN, Oberschleissheim (DE); Christoph ARNDT, Hannover (DE)

(21) Appl. No.: 19/101,439

(22) PCT Filed: Jul. 28, 2023
(86) PCT No.: PCT/EP2023/071074

§ 371 Date: Feb. 5, 2025

(30) Foreign Application Priority Data
Aug. 5, 2022 (DE) 102022119798.0

(51) Int. Cl. H04L 12/40; G05B 15/02

(52) U.S. Cl. CPC H04L 12/40039; G05B 15/02; H04L 2012/40273

(57) ABSTRACT

Embodiments of the present invention provide a method 100 for a control device of a vehicle to reduce energy consumption. The method 100 comprises receiving 110, from a central control device, a signal indicative of an access plan for a bus connected to the control device and a task plan. Further, the method 100 comprises activating 120 the bus based on the access plan and starting 130 a task on the control device based on the task plan.

A zonal electronic/electrical (EE) architecture is a concept that addresses technological change in the automotive industry. Requirements for an EE system have risen sharply, driven by digitalization and consumer wishes. An increasing amount of electronics and functions are finding their way into vehicles.

The current EE architecture has reached its scalability limit. The zonal EE architecture concept developed specifically for the vehicle industry introduces two new device classes, vehicle servers and zonal gateways. Together with the use of a backbone bus, e.g., Ethernet, the number of physical control devices may be reduced and the cabling optimized. At the same time, it completes the transition from control device orientation to function orientation. This means that functions are no longer linked to control devices.

The vehicle server concentrates the computing resources by consolidating several physical control devices in one high-performance computer. The zonal gateway acts as a local connectivity hub that forwards data to the backbone, a central control device, via a high-speed Ethernet connection. The use of an Ethernet network enables the scalability of functionalities and the flexible interchangeability of components. The vehicle industry may thus reduce inefficiencies in production and at the same time use any number of network configurations.

Operating states of individual control devices of the zonal architecture are controlled via terminals, alarm lines, etc. With zonalization into individual zone modules, the control devices are connected via a backbone bus and provide individual integration platforms for software development. Driving the individual control devices may be problematic here. Especially because individual control devices may take several seconds to start up due to their operating systems. Sub-network operation of the zone modules is therefore difficult. In particular, essentially all control devices may always be switched on from the vehicle's ready-to-drive state. This results in a high energy consumption.

US 2007/0 081 473 A1 discloses a system comprising a system configuration manager and a plurality of electronic control devices each comprising a configuration manager. Each configuration manager saves current configuration data for task completion and access to buses. When the system is in operation, the configuration manager may send updated configuration data to the electronic control devices.

DE 10 2005 055 173 A1 discloses an electronic control unit with a plurality of layers of distributed network control functionality. For example, three layers of distributed network control functionality are defined in the ECU. The three functionality layers comprise an application layer, a system infrastructure layer and a hardware abstraction layer. The system structure control device determines electronic control units that are put into sleep mode. A wake-up and/or wake operation of the electronic control units is determined in the same way.

DE 10 2021 108 669 A1 discloses a method comprising identifying a plurality of stations included in a first network and generating a network traffic plan arranged to assign a plurality of service periods to the plurality of stations. The network traffic plan identifies a plurality of idle periods and waking times for the plurality of stations. Further, the method comprises sending a query frame to at least one station of the plurality of stations during a designated service period and receiving a data transmission from the at least one station.

There is therefore a need to improve an energy consumption of a control device. Said demand is satisfied by the methods, the computer program, the apparatus and the vehicle of the independent claims.

Embodiments are based on the core idea that energy consumption of an EE system of a vehicle may be reduced by activating individual buses and/or control devices (and/or a processor of a control devices) only when they are needed (i.e., selective activation of a bus and/or control device), for example to perform a task or for communication. If a bus and/or a control device is not required, it may be deactivated, for example by putting it into an idle mode in order to reduce energy consumption.

Embodiments relate to a method for a control device of a vehicle to reduce energy consumption, comprising receiving, from a central control device, a signal indicative of an access plan for a bus connected to the control device and a task plan, activating the bus based on the access plan, and starting a task on the control device based on the task plan. This may reduce the energy consumption of a bus, for example a bus between the control device and a sensor. Furthermore, energy consumption of the control device may be reduced, for example by activating a control device only to complete a task from an idle state. For example, the control device may only be activated when a task is to be performed by the control device. For example, the computing power of the control device may be reduced and then increased again when a task is started.

In one embodiment, starting the task be synchronized with activating the bus. This may reduce a dead time, as the activation of individual components, such as the activation of a microprocessor of the control device, may be coordinated with the receipt of information via the bus.

In one embodiment, the method may further comprise sending an activation signal to an electronic component that is connected to the control device via the bus. This allows, for example, a sensor or an actuator to be activated via a field bus.

In one embodiment, the method may further comprise configuring the bus to an energy saving mode. This means, for example, that a bus between an electronic component and the control device may be configured in such a way that it is in a bus idle state in relation to the control device when no communication is planned by the control device on the bus.

In one embodiment, the method may further comprise configuring the control device to an energy saving mode based on the task plan. This allows an operating state of the control device to be adapted to a task to be performed, which may reduce energy consumption.

In one embodiment, the method may further comprise receiving, from an electronic component, an initialization signal indicative of an operating mode of an electronic component and transmitting, to the central control device, a notification signal indicative of the operating mode of the electronic component. This allows the central control unit to be informed, for example, when a sensor is actuated, e.g., to open a vehicle door.

In one embodiment, the method may further comprise deactivating the activated bus based on the access plan. This allows, for example, a backbone bus between the control device and a central control device and/or a field bus between the control device and an electronic component to be deactivated, which may reduce energy consumption.

In one embodiment, the method may further comprise completing the task based on the task plan. This may minimize the energy consumption of a control device.

In one embodiment, the method may further comprise suspending the task based on the task plan. This may improve the performance of a task.

Embodiments relate a method for a central control device to reduce power consumption comprising sending, to a control device, a signal indicative of an access plan for a bus connected to the control device and a task plan.

In one embodiment, the method may further comprise sending, to a second control device, a second signal. Execution of a function on the control device and the second control device may be synchronized using the signal and the second signal. This allows a plurality of control devices to be operated in a synchronized manner, which may improve the processing of a function, for example comprising a task on the control device and a task on the second control device.

Embodiments also provide a computer program for performing any of the methods described herein when the computer program is running on a computer, a processor, or a programmable hardware component.

Another embodiment is an apparatus for a vehicle to reduce energy consumption. The apparatus comprises an interface for communication with a central control device or a control device and a data processing circuit configured to perform at least one of the methods described herein. Embodiments further provide a vehicle with an apparatus as described herein.

Embodiments will be described in more detail below with reference to the accompanying figures, in which:

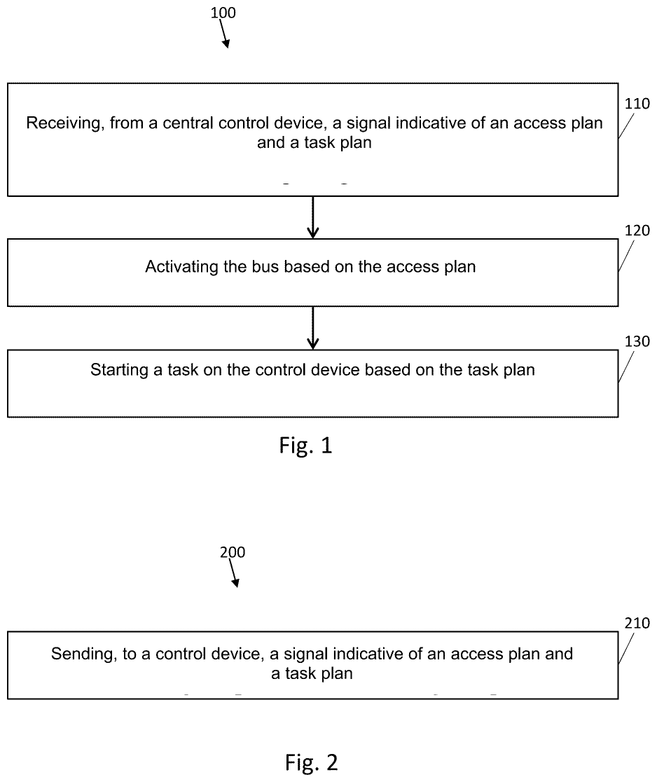

FIG. 1 shows an example of a method for a control device of a vehicle to reduce energy consumption;

FIG. 2 shows an example of a method for a central control device of a vehicle to reduce energy consumption;

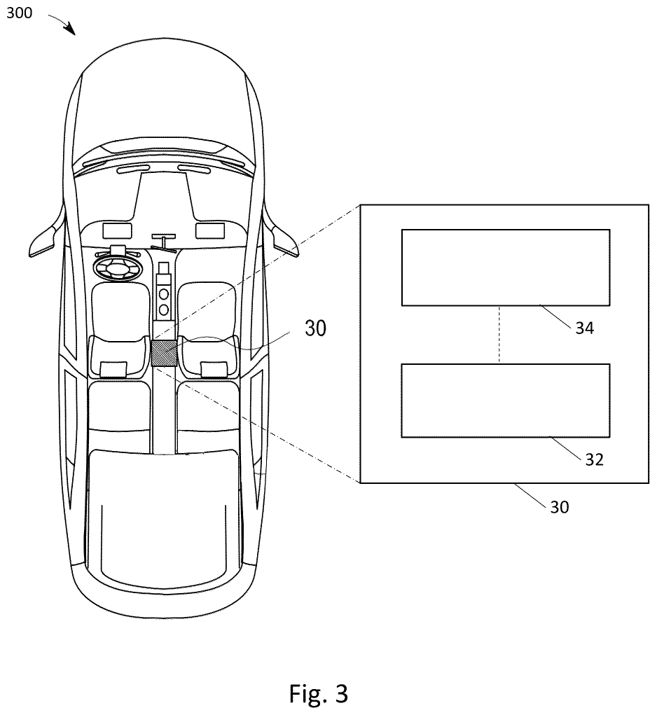

FIG. 3 shows a block diagram of an embodiment of an apparatus for a vehicle; and

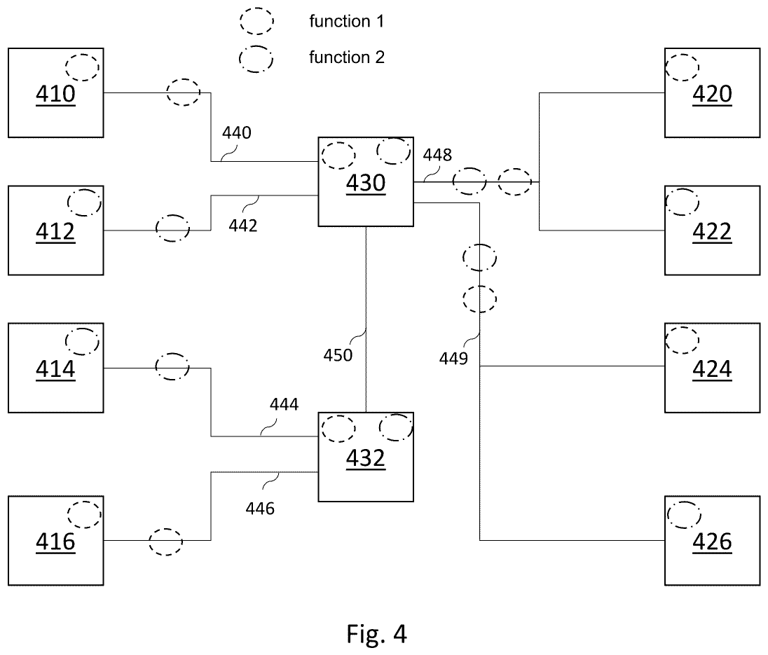

FIG. 4 shows a functional network in an EE architecture.

Various embodiments will now be described more fully with reference to the accompanying drawings in which some embodiments are illustrated. In the figures, the thickness dimensions of lines, layers and/or regions may be exaggerated for clarity.

FIG. 1 shows a schematic representation of a method 100 for a control device of a vehicle to reduce energy consumption. The method 100 comprises receiving 110, from a central control device, a signal indicative of an access plan for a bus connected to the control device and a task plan. Further, the method 100 comprises activating 120 the bus based on the access plan and starting 130 a task on the control device based on the task plan. The bus and/or the control device may be activated selectively, for example only when it is required to perform a task. For example, at least one bus and/or control device cannot be activated. For example, it is possible to check which bus and/or control device is to be activated (e.g., by using a look-up table). In particular, only buses and/or control devices that are required to perform a task may then be activated. Buses and/or control devices that are not required may remain deactivated and/or be selectively deactivated. With selective activation, not all buses and/or control devices may be activated. In particular, activation may comprise activating the bus and/or control device in different operating modes. In particular, the bus and/or the control device may be set to an operating mode required for a task. For example, a bus and/or control device may comprise a plurality of operating modes. An operating mode required for a task may then be determined and selectively activated. This allows the control device to control its own bus access depending on the access plan, which may reduce the energy consumption of the control device for communication via the bus. Furthermore, an operating mode of the control unit may be selected depending on the task plan. For example, the control device may be in an idle mode (e.g., an energy-saving mode) when there is no task to be performed. The task plan may be used to inform the control device when a task is to be processed and may accordingly activate a microprocessor from idle mode to operating mode.

In particular, the bus may be switched from idle mode to operating mode by the control device. In the operating mode, the control device may communicate using the bus, for example by transmitting data using the bus.

In particular, the access plan may include data on the use of the bus for communication, especially times at which the bus is to be used for communication. For example, the access plan includes data on the use of a plurality of buses of the control device for communication tasks. For example, the access plan may define a time of use of the bus and/or an access mechanism.

The signal may include the access plan so that the control device receives the access plan directly via the signal. Alternatively, the signal may include information about the receipt of the access plan by the control device. For example, the control device may determine an access plan from a lookup table or a database. The lookup table/database may be stored in a memory device of the control device. This may reduce data transfer between the central control device and the control device.

The access plan, also known as the MAP (Medium Access Plan), may be received from the central control device via a backbone bus. For example, a MAP may be received regularly, e.g., at periodic intervals (e.g., every 20-40 ms) by the control device. For example, a MAP may be transmitted in the middle of a time window of periodic intervals. The MAP may include various data. This means, for example, that activation of the bus may be adapted to a changed situation. In particular, the MAP may be updated by receiving it regularly. For example, a previously received MAP may include a time for receiving a second (later) MAP so that the control device may configure the (backbone) bus in such a way that it is activated to receive the second MAP and is otherwise deactivated, i.e., in idle mode.

In particular, time slots and/or various access mechanisms (medium access) such as time-division multiple access (TDMA), carrier-sense multiple access (CSMA), MiniSlots and frequency-division multiple access (FDMA) may be defined in the MAP for the respective messages to be communicated via the bus. Optionally, a transmission channel may also be defined on the (backbone) bus for the MAP (FDMA). The MAP may be used to inform the control device of a time when messages are to be received using the bus. Accordingly, the times at which the bus is in a bus idle state may also be defined, i.e., the bus may be deactivated and energy may be saved. Bus idle state may mean in particular that the bus is not used by the control device. The bus is therefore in a bus idle state in relation to the control device. Other control devices may still use the bus for communication.

The bus that is activated based on the access plan may be a backbone bus for communication between the control device and the central control device, for example for receiving the signal, or a field bus for communication between the control device and an electronic component, for example a sensor or actuator. For example, the access plan may also include information for activating a number of buses, such as the backbone bus and a field bus. The backbone bus may enable faster data transmission than a field bus.

The task plan may be used in particular to provide the control device with information about tasks to be performed. This allows the control device to adapt an operating mode, for example the number of microprocessors in an idle mode, to the tasks to be performed. The task plan, also referred to as the task activity plan (TAP), may include the tasks associated with the control device. The tasks may be part of a function. In particular, a function may include associated tasks and/or communications. Furthermore, the TAP may include the tasks of several functions belonging to a vehicle function. A vehicle function may therefore comprise a plurality of functions. In particular, the MAP and TAP may be used to control a wide range of functions and/or vehicle functions.

In particular, the TAP may include all tasks that are to be performed by the control device, for example until a new TAP is received. The TAP may be updated with any signal. For example, a TAP may be received from the control device simultaneously or consecutively with each MAP. Alternatively, a TAP may also be used for several consecutive MAPs. Alternatively, a MAP may also be used for several consecutive TAPs.

By combining the TAP and the MAP, the control device may activate the sensors, actuators and buses required for a task and/or communication. These required sensors, actuators and buses may therefore be in an idle state until they are activated by the control device, so that the energy consumption of the vehicle's EE system may be reduced.

In one embodiment, starting the task may be synchronized with activating the bus. This allows the components required to perform a task to be synchronized, thus reducing latencies. For example, dead times between receiving data through communication via the bus and starting a task on the control device, such as a calculation based on data received using the bus, may be reduced or avoided.

In one embodiment, the method 100 may further comprise sending an activation signal to an electronic component that is connected to the control device using the bus. An electronic component may be, for example, a sensor or an actuator of the vehicle. This means that the electronic component may only be activated when it is needed, for example due to the task plan. Optionally, the electronic component may also be deactivated again by a deactivation signal so that energy consumption may be reduced.

In one embodiment, the method 100 may further comprise configuring the bus to an energy saving mode based on the access plan. The bus, in particular the backbone bus, may be configured based on the access plan of the signal in such a way that it only has sufficient functionality, e.g., data rate, to transmit a signal. For example, instead of being put into idle mode, the bus may be configured with a lower data rate. Optionally, the performance of the backbone bus may also be throttled to the capacity actually required, e.g., through simpler modulation/coding, which may reduce energy consumption.

For example, if the control device has no task to perform, only a communication link may be maintained to the central control device using the backbone bus, in particular during a communication time slot.

In one embodiment, the method 100 may further comprise configuring the control device to an energy saving mode based on the task plan. In particular, a computing capacity of the control device may be reduced. For example, individual microprocessors of the control device may be shut down or put into an idle state. This may reduce an energy consumption of the control device. For example, if a control device obtains data from the signal that it has no tasks to perform, it may switch to idle mode, for example by shutting down individual microprocessors and/or computing cores.

In one embodiment, the method 100 may further comprise receiving, from an electronic component, an initialization signal indicative of an operating mode of an electronic component and transmitting, to the central control device, a notification signal indicative of the operating mode of the electronic component. For example, the control device may receive the initialization signal from a sensor. The initialization signal may indicate use or intended use of the sensor by the user. For example, a sensor may be included in a door handle of the vehicle and activated when the door handle is operated. For example, a sensor may be a vehicle key and an intended use may be recognized by an approach to the vehicle and lead to an activation of the vehicle key. The control device may be informed about the activation of the sensor by the initialization signal and send a notification signal to the central control device. Based on the notification signal, the central control device may create a new access plan and/or a new task plan, e.g., to transfer the vehicle from an idle state to an operating state. This new access plan and/or task plan may then be sent to the control device using the signal, allowing it to activate required components.

An electronic component may notify the control device via a field bus, for example. The field bus may be permanently configured to transmit an initialization signal. The control device may have an interface that is permanently in operation to receive an initialization signal. This may reduce an overall energy consumption of the control device while still receiving an initialization signal from the electronic component. Alternatively, a wake-up line or a virtual wake-up line may be provided from the electronic component to the control device. The virtual wake-up line for transmitting the initialization signal may include one or more subcarriers that are reserved for a wake-up (OFDM) or a special service channel, such as TC10 for Ethernet.

The control device may send the message via the backbone bus to the central control device in a free message slot (transmission opportunity) or during a bus idle state. In particular, an interface of the central control device is permanently active to receive a notification signal. The central control device may then take the notification signal into account when generating the next signal and adapt an access plan and/or task plan accordingly.

An operating mode of the electronic component may be an active operating mode of the electronic component, for example by actuation by a user or detection of an event that requires activation of the electronic component.

In one embodiment, the method 100 may further comprise deactivating the activated bus based on the access plan. This may save energy, as the bus, for example a field bus, is only active when it is needed.

In one embodiment, the method 100 may further comprise completing the task based on the task plan. In one embodiment, the method 100 may further comprise suspending the task based on the task plan. This may lead to an effective performance of a task of the task plan.

More details and aspects are mentioned in connection with the embodiments described below. The embodiment shown in FIG. 1 may comprise one or more optional additional features corresponding to one or more aspects mentioned in connection with the proposed concept or one or more embodiments described below (e. g. FIG. 2-4) .

FIG. 2 shows an example of a method 200 for a central control device of a vehicle to reduce energy consumption. The method 200 comprises transmitting, to a (first) control device, a (first) signal indicative of an access plan for a bus connected to the control device and a task plan. The method 200 for the central control device may be carried out in particular in connection with the method for a control device from FIG. 1 (in particular within the meaning of transmitter and receiver). For example, a central control device may create the signal indicative of the access plan and the task plan and send it to the control device.

In one embodiment, the method 200 may further comprise sending, to a second control device, a second signal. Execution of a function on the control device and the second control device may be synchronized using the signal and the second signal. This allows the central control device to manage synchronization of related tasks of a function on distributed control devices (the (first) control device and the second control device).

The second signal is indicative of an access plan for a bus connected to the second control device and a task plan. The second signal may be identical to the (first) signal. Alternatively, the second signal may be different from the first signal, for example comprising a second access plan and/or a second task plan specifically for the second control device. In particular, the access plan/task plan and the (second) access plan/task plan may be used to synchronize the execution of a function comprising tasks on the control device and the second control device. This may reduce the latency time for the function execution. In addition, the central control device may manage communication on the distributed control devices. The central control device may therefore generally synchronize the functions of the distributed control devices, e.g., for processing a vehicle function. In particular, this may improve the control of an activity status of a task. It may also be used to control functional networks.

More details and aspects are mentioned in connection with the embodiments described below and/or above. The embodiment shown in FIG. 2 may comprise one or more optional additional features corresponding to one or more aspects mentioned in connection with the proposed concept or one or more embodiments described above (e.g., FIG. 1) and/or below (e.g., FIG. 3-4).

FIG. 3 shows a block diagram of an embodiment of an apparatus 30 for a vehicle 300. The apparatus 30 for a vehicle 300 for reducing an energy consumption comprises an interface 32 for communication with a central control device (as described for the method in FIG. 2) or a control device (as described for the method in FIG. 1). The apparatus 30 further comprises a data processing circuit 34 configured to perform at least one of the methods described herein, for example the method described with reference to FIG. 1 or FIG. 2. Further embodiments include a vehicle 300 with an apparatus 30.

For example, the interface 32 shown in FIG. 3 may correspond to one or more inputs and/or one or more outputs for receiving and/or transmitting information, such as in digital bit values based on a code, within a module, between modules, or between modules of different entities. The interface 32 may, for example, be configured to communicate with other network components via a (radio) network or a local connection network, for example comprising a bus.

In embodiments, the data processing circuit 34 may correspond to any controller or processor or a programmable hardware component. For example, the data processing circuit 34 may also be implemented as software programmed for a corresponding hardware component. In this respect, the data processing circuit 34 may be implemented as programmable hardware with appropriately adapted software. Any processor, such as digital signal processors (DSPs), may be used. In this context, embodiments are not limited to a particular type of processor. Any processor or multiple processors as well for implementing the data processing circuit 34 are conceivable.

As shown in FIG. 3, the interface 32 may be coupled to the respective data processing circuit 34 of the apparatus 30. In examples, the apparatus 30 may be implemented using one or more processing units, one or more processing devices, any means for processing, such as a processor, a computer or a programmable hardware component, which may be operated with accordingly adapted software. Similar, the described functions of the data processing circuit 34 may as well be implemented in software, which is then executed on one or more programmable hardware components. Such hardware components may be a general-purpose processor, a digital signal processor (DSP), a microcontroller, etc. The data processing circuit 34 may be capable of controlling the interface 32, so that any data transmission that occurs via the interface 32 and/or any interaction that may involve the interface 32 may be controlled by the data processing circuit 34.

In one embodiment, the apparatus 30 may comprise a memory and at least one data processing circuit 34 operably coupled to the memory and configured to perform the method described below.

In examples, the interface 32 may correspond to any means for obtaining, receiving, transmitting, or providing analog or digital signals or information, e.g., any terminal, contact, pin, register, input terminal, output terminal, conductor, lane, etc. which allows providing or obtaining a signal or information. The interface 32 may be wireless or wired and may be configured to be able to communicate with other internal or external components, such as to send or receive signals or information.

In at least some embodiments, the vehicle 300 may correspond to, for example, a land vehicle, a water vehicle, an aircraft, a rail vehicle, a road vehicle, a car, a bus, a motorcycle, an all-terrain vehicle, a motor vehicle, or a truck. The data processing circuit 34 may, for example, be part of a control device of the vehicle.

More details and aspects are mentioned in connection with the embodiments described below and/or above. The embodiment shown in FIG. 3 may comprise one or more optional additional features corresponding to one or more aspects mentioned in connection with the proposed concept or one or more embodiments described above (e.g., FIG. 1-2) and/or below (e.g., FIG. 4).

FIG. 4 shows a functional network in an EE architecture. The functional network comprises a plurality of sensors 410, 412, 414, 416 and a plurality of actuators 420, 422, 424, 426. The functional network also includes a central control unit 430, which is connected to a control unit 432 via a backbone bus 450. The central control unit 430 comprises two zone modules and the control unit 432 comprises one zone module. In particular, the control devices 430, 432 may be integration platforms for the applicative scope of vehicle functions.

Function 1 and function 2 require computing capacities on their participating components, for example the control devices 430, 432, the sensors 410, 416 and/or 412, 414 and actuators 420, 424 and/or 422, 426. Furthermore, functions 1 and 2 require communication capacities on the participating field buses 440, 446, 448, 449 and/or 442, 444, 448, 449 and the backbone bus 450.

To start and end function 1, the required tasks may then be started on the individual sensors 410, 416, actuators 420, 424 and control units 430, 432. Communication between the components involved takes place via the field buses involved 440, 446, 448, 449 and the backbone bus 450. Function 2 may be started and stopped in the same way.

More details and aspects are mentioned in connection with the embodiments described above. The embodiment shown in FIG. 4 may comprise one or more optional additional features corresponding to one or more aspects mentioned in connection with the proposed concept or one or more embodiments described above (e. g. FIG. 1-3) .

Further embodiments are computer programs for performing any of the methods described herein when the computer program is running on a computer, a processor, or a programmable hardware component. Depending on certain implementation requirements, embodiments of the invention may be implemented in hardware or software. The implementation may be performed using a digital storage medium, such as a floppy disk, a DVD, a Blu-Ray, a CD, a ROM, a PROM and EPROM, an EEPROM, or a FLASH memory, a hard drive or any other magnetic or optical memory on which electronically readable control signals are stored that may interact or interact with a programmable hardware component such that the respective method is performed.

A programmable hardware component may be formed by a processor, a computer processor (CPU; Central Processing Unit), a graphics processor (GPU; Graphics Processing Unit), a computer, a computer system, an application-specific integrated circuit (ASIC; Application-Specific Integrated Circuit), an integrated circuit (IC; Integrated Circuit), a single-chip system (SOC; System on Chip), a programmable logic element or a field-programmable gate array with a microprocessor (FPGA; Field Programmable Gate Array).

The digital storage medium may therefore be machine-or computer-readable. Thus, some embodiments comprise a data carrier having electronically readable control signals capable of interacting with a programmable computer system or a programmable hardware component such that one of the methods described herein is performed. Thus, an embodiment is a data carrier (or a digital storage medium or a computer-readable medium) on which the program for performing one of the methods described herein is recorded.

In general, embodiments of the present invention may be implemented as a program, firmware, computer program or computer program product comprising program code or data, wherein the program code or data is effective to perform one of the methods when the program is running on a processor or programmable hardware component. The program code or the data may also be stored on a machine-readable carrier or data carrier, for example. The program code or the data may be available as source code, machine code or byte code as well as other intermediate code.

The embodiments described above are merely illustrative of the principles of the present invention. It is understood that modifications and variations of the arrangements and details described herein will be apparent to others skilled in the art. Therefore, it is intended that the invention be limited only by the scope of protection of the following claims and not by the specific details presented by the description and explanation of the embodiments herein.

### LIST OF REFERENCE NUMERALS

30 apparatus
32 interface
34 data processing circuit
100 method for a control device
110 receiving, from a central control device, a signal indicative of an access plan
120 activating the bus based on the access plan
200 method for a central control device
210 sending, to a control device, a signal indicative of an access plan
300 vehicle
410, 412 414, 416 sensor
420, 422, 424, 426 actuator
430 central control device
423 control unit
440, 442, 444, 446, 448, 449 field bus
450 backbone bus

1. A method for a control device of a vehicle to reduce energy consumption comprising:
receiving, from a central control device, a signal indicative of an access plan for a bus connected to the control device and a task plan;
selectively activating the bus based on the access plan when the bus is required to perform a task; and
starting the task on the control device based on the task plan.

2. The method of claim 1, wherein
starting the task is synchronized with activating the bus.

3. The method of claim 1, further comprising
sending an activation signal to an electronic component that is connected to the control device using the bus.

4. The method of claim 1, further comprising
configuring the bus to an energy-saving mode based on the access plan.

5. The method of claim 1, further comprising
configuring the control device to an energy-saving mode based on the task plan.

6. The method of claim 1, further comprising:
receiving, from an electronic component, an initialization signal indicative of an operating mode of an electronic component; and
sending, to the central control device, a notification signal indicative of the operating mode of the electronic component.

7. The method of claim 1, further comprising
deactivating the activated bus based on the access plan.

8. The method of claim further comprising
completing the task based on the task plan.

9. The method of claim 1, further comprising
suspending the task based on the task plan.

10. A method for a central control device to reduce power consumption comprising
sending, to a control device, a signal indicative of an access plan for a bus connected to the control device and a task plan.

11. The method of claim 10, further comprising
sending, to a second control device, a second signal, wherein an execution of a function on the control device and the second control device is synchronized using the signal and the second signal.

12. A non-transitory, computer-readable medium comprising program code for performing one of the methods of any one of the preceding claims, when the program code is running on a computer, a processor, or a programmable hardware component.

13. An apparatus for a vehicle to reduce energy consumption comprising:
an interface for communication with a central control device or a control device; and
a data processing circuit configured to perform at least one of the methods of claim 1.

14. A vehicle comprising an apparatus of claim 13.

15. An apparatus for a vehicle to reduce energy consumption comprising:
an interface for communication with a central control device or a control device; and
a data processing circuit configured to perform at least one of the methods of claim 10.

16. A vehicle comprising an apparatus of claim 15.
